(19) United States
(12) Patent Application Publication
(10) Pub. No.: US 2009/0084363 A1
(43) Pub. Date: Apr. 2, 2009

(54) Regeneration of Evaporative Emision Control System for Plug-in Hybrid Vehicle

(75) Inventor: Sam R. Reddy, West Bloomfield, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/182,169

(22) Filed: Jul. 30, 2008

Related U.S. Application Data
(60) Provisional application No. 60/975,573, filed on Sep. 27, 2007.

(51) Int. Cl. F02M 33/04

(52) U.S. Cl. 123/520; 903/902

(57) ABSTRACT

A plug-in hybrid vehicle is driven by one or more electric motors powered by a battery system with supplemental electric power provided by a gasoline engine powered generator. A canister with fuel vapor adsorptive material, connected by a fuel vapor vent passage, is used to admit and temporarily adsorb fuel vapor from a vehicle fuel tank during refueling and diurnal heating. The canister also has an air flow passage for venting the canister and introducing ambient air (in the reverse flow direction) for removing vapor stored in the canister during canister purging. The canister has a second passage for conducting air and purged vapor from the canister to the operating engine. When engine operation is insufficient to purge fuel vapor from the fuel adsorptive material, microwave energy is used to heat the material to purge adsorbed fuel vapor and drive the vapor back through the fuel vapor vent passage into the fuel tank. A vacuum pump in the vent passage may assist the flow of the purged fuel vapor.

This application claims the benefit of U.S. Provisional Application No. 60/975,573, titled “Regeneration of Evaporative Emission Control System For Plug-In Hybrid Vehicle”, and filed Sep. 27, 2007.

### TECHNICAL FIELD

This invention pertains to the management of fuel tank gasoline vapor produced in operation of battery powered, electric motor driven automotive vehicles having a gasoline engine for generating supplemental electrical power on extended driving trips. An on-board activated carbon canister is provided for adsorption of fuel vapor expelled from a fuel tank during refueling and diurnal heating cycles. This invention pertains to the use of microwave heating of the canister to return stored fuel vapor to the fuel tank, especially when engine operation does not purge the canister of stored fuel vapor.

### BACKGROUND OF THE INVENTION

There is interest in producing passenger vehicles driven by an electric motor powered by a re-chargeable battery (for example, a lithium-ion battery). The operating range of the battery powered vehicle would be increased using an on-board electric generator driven, upon demand, by a gasoline engine. For relatively short driving excursions, the capacity of the battery would suffice and the gasoline engine would not be started. At the completion of such trips the battery would be recharged from a 110 volt AC source. Such a vehicle is sometimes called a plug-in hybrid vehicle.

Since many local driving trips could be completed within the electrical power capacity of the battery it is anticipated that many days could pass without starting the gasoline engine. But the engine would be necessary when longer trips are taken. By way of example, it is contemplated that battery-only trips (before plug-in recharging) may be of up to about forty miles. But the gasoline engine-driven electric generator would be used to increase the range of the vehicle to several hundred miles.

Despite its intermittent usage the plug-in hybrid gasoline engine will, of course, require on-board fuel storage. Gasoline stored in a vehicle fuel tank is exposed to ambient heating which increases the vapor pressure of the volatile hydrocarbon fuel. In conventional gasoline powered engines, fuel tank vapor (typically comprising lower molecular weight hydrocarbons) is vented to a canister containing high surface area carbon granules for temporary adsorption of fuel tank emissions. Later, during engine operation ambient air is drawn through the carbon granule bed to purge adsorbed fuel vapor from the surfaces of the carbon particles and carry the removed fuel into the air induction system of the vehicle engine. As stated, such plug-in hybrid vehicles operate mostly on batteries which are charged during the night by plugging into home AC outlets. A plug-in hybrid vehicle IC engine may not run for several days which results in no purging (cleaning) of the evaporative emission control canister by engine operation. However, a conventional fuel tank will be generating diurnal vapors everyday. It would be desirable to use the familiar canisters but the mode of their operation must be altered to contain fuel vapor tending to flow from the fuel tank. This invention provides a method of purging a familiar fuel evaporative emission control canister in a method of operation adapted for a plug-in hybrid type vehicle.

### SUMMARY OF THE INVENTION

This invention provides a method of operating a fuel storage and delivery system for a plug-in hybrid type vehicle. The vehicle has a fuel storage and delivery system for operation of a gasoline engine that operates on demand for powering a generator for recharging a vehicle battery system and for providing supplemental electrical power for the electric motor or motors driving the wheels of the vehicle. In order to meet federal and state evaporative emission standards it is necessary to devise and operate a fuel storage and delivery system that releases little or no fuel from the vehicle at any time.

In accordance with one embodiment, a fuel tank is provided for a gasoline-fueled engine specified for on-demand powering of a generator for a plug-in hybrid vehicle. The tank has a filler pipe with a closure for refueling, a fuel pump and fuel line for delivery of fuel to the engine. The tank has sensors for detecting fuel level, fuel temperature and fuel tank pressure. And the tank has a fuel vapor vent line leading from the tank to the vapor inlet of an evaporative emission control (EVAP) canister. The EVAP canister stores both refueling and diurnal vapors. The EVAP canister has an air inlet line for purging the canister of adsorbed fuel vapor during the periodic on-demand engine operation. The EVAP canister also has an outlet line for conducting of airborne fuel vapor drawn from the canister to the air intake system of the gasoline engine. Flow in each of the air inlet purge line and canister outlet purge line are controlled by suitable valves which may be electrical solenoid actuated valves. A computer control module (which may also be controlling other engine or vehicle functions) receives fuel temperature, fuel level and fuel tank pressure input in controlling the operation of the control valves.

In accordance with an embodiment of the invention, means are provided for delivering microwave energy to the canister when it is determined that it contains a quantity of fuel vapor which needs to be purged. Loading of the canister may be detected, for example, from accumulated fuel temperature data stored in an engine control module. When it is determined by any suitable means that fuel vapor should be removed from the canister, microwave energy is directed into the bed of adsorbent particles within the canister to heat the bed of adsorbent particles from the inside out so that adsorbed fuel vapor is expelled from the bed and driven back into the cooler fuel tank. There the expelled vapor condenses or is maintained under a slight fuel tank pressure. After a brief period of heating the canister, the source of microwave energy is turned off and the emptied canister is available for fuel vapor storage.

In some embodiments of the invention, the flow of vapor expelled from the canister may be enhanced by operation of a vacuum pump in the fuel tank vent line.

This microwave heating practice is followed when vehicle operation does not require sufficient engine operation for air flow purging of fuel vapor from the EVAP canister as the engine is used to power the vehicle generator.

Other advantages of the invention will be seen from a description of preferred embodiments which follows.

### BRIEF DESCRIPTION OF THE DRAWINGS

FIG. 1 is a schematic drawing of a vehicle fuel tank for the gasoline engine of a plug-in hybrid vehicle. The fuel tank has a vent line to an evaporative fuel vapor recovery (EVAP) canister. The EVAP canister has a vent line with a solenoid controlled vent valve. In this embodiment the canister is enclosed in a microwave generator for heating the fuel-adsorbent particles of the canister to expel adsorbed gasoline vapor for return to the fuel tank.

FIG. 2 is a schematic drawing similar to FIG. 1 except that the microwave generator is separate from the EVAP canister and a wave guide carries the microwave radiation from the microwave generator to the EVAP canister.

FIG. 3 is a schematic drawing of an evaporative control system for a plug-in hybrid vehicle including a microwave generator separate from the EVAP canister.

### DESCRIPTION OF PREFERRED EMBODIMENTS

A plug-in hybrid automotive vehicle has a suitable re-chargeable battery system that typically powers at least one electric motor for driving at least two wheels of the vehicle. As the vehicle operator drives the vehicle, a programmed computer is used to manage the operation of the electric motor and motive power delivered to the wheels in response to operator demand. While the battery system may be charged when the vehicle is not being driven, vehicle range even with a fully charged battery system is limited. In the subject hybrid electric motor-powered vehicle, an on-board gasoline powered engine is provided to power an electric generator to drive the electric motor when the battery reaches a low-charge condition. The focus of this invention and the following illustrations is on the fuel tank and evaporative emission control system for the plug-in hybrid vehicle gasoline engine.

Fuel evaporative emission control systems have been in use on gasoline engine driven automotive vehicles for many years. The gasoline fuel used in many internal combustion engines is quite volatile and usually formulated to provide suitable seasonal volatility. The fuel typically consists of a hydrocarbon mixture ranging from high volatility butane (C-4) to lower volatility C-8 to C-10 hydrocarbons. During daytime heating (i.e., diurnal heating), fuel temperature increases. The vapor pressure of the heated gasoline increases and fuel vapor will flow from any opening in the fuel tank. Normally, to prevent vapor loss into the atmosphere, the tank is vented through a conduit to a canister containing suitable fuel adsorbent material. High surface area activated carbon granules are widely used to temporarily adsorb the fuel vapor. The same adsorbent material is used for storing fuel vapor expelled from the fuel tank during vehicle fueling. This invention adapts such a fuel evaporative emission control system for use in a plug-in hybrid vehicle. It provides a method of purging fuel from a fuel-loaded EVAP canister when the engine is not running or is not running long enough to purge fuel vapor from a loaded canister.

On a conventional vehicle, the canister is purged by pulling ambient air through the evaporative emission control canister using engine manifold vacuum and the purged vapor is consumed in engine combustion. In the case of a plug-in hybrid vehicle, the canister may not be purged but the fuel tank will be generating diurnal vapors everyday. If the canister is not purged, the diurnal vapors will escape into the atmosphere as uncontrolled diurnal emissions.

In accordance with an embodiment of this invention, microwave energy is used to purge fuel laden activated carbon of a plug-in hybrid EVAP canister.

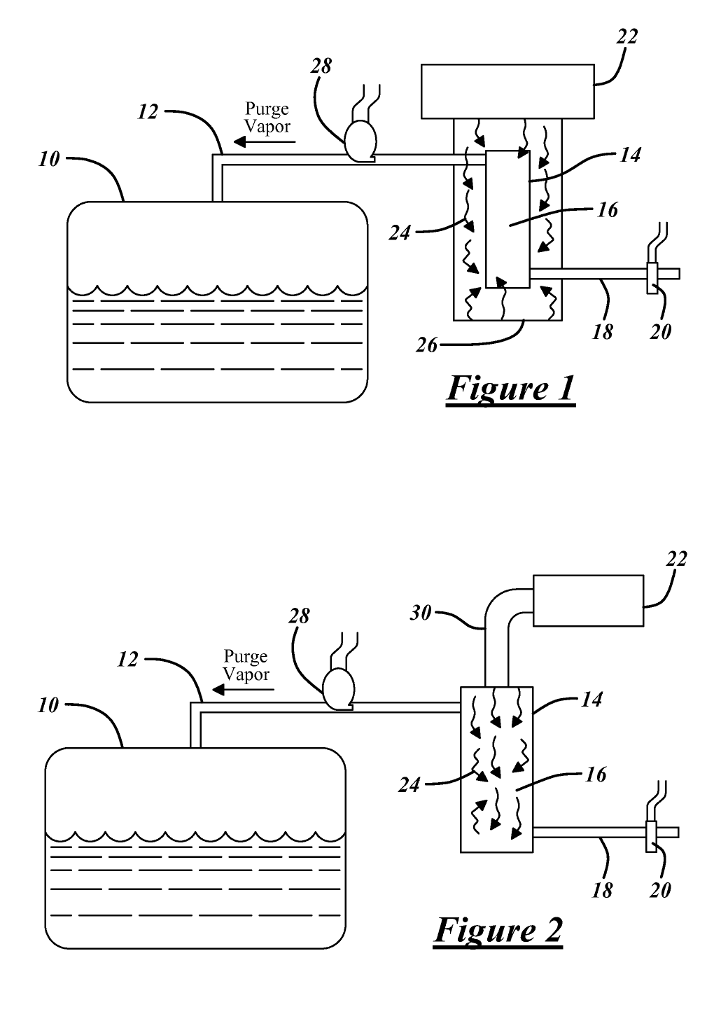

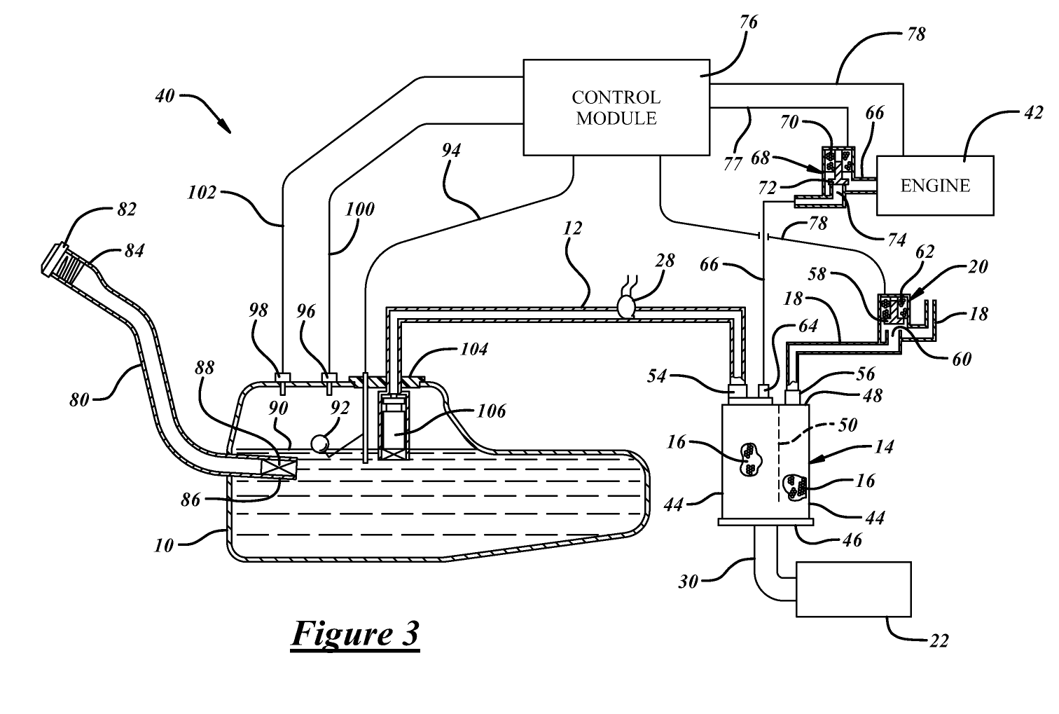

Reference is made to FIG. 1 which is a schematic view of a fuel tank 10 for a plug-in hybrid vehicle. The representation of the fuel tank 10 is simplified in that the fuel inlet, fuel pump, fuel delivery line to the vehicle engine, and fuel temperature and pressure sensors are not shown. The fuel tank 10 is usually located so that it is isolated from engine and exhaust heat, but the fuel tank is subject to ambient heating. The fuel tank 10 has a vapor line (fuel vapor vent passage) 12 which permits the flow of fuel vapor, under its vapor pressure, to leave the top of the tank and flow to the vapor inlet (54 in FIG. 3) at the top of an EVAP canister 14 containing a specified mass of adsorbent particles 16, for example but not limited to activated carbon particles 16. The activated carbon particles 16 may be contained as a bed of particles in a canister of nylon or other material that does not absorb microwave energy. The canister of activated carbon is illustrated with a canister vent line (first air and fuel vapor flow passage) 18 that may be opened or closed by operation of a canister vent solenoid 20.

In FIG. 1 the canister 14 is contained within a suitable microwave generator 22 that, upon a signal from a suitable computer control module (not shown) directs microwave energy 24 into the bed of activated carbon 16 through the nylon container which is transparent to microwaves. The EVAP canister 14 may be contained in a microwave leak free container 26 (e.g., aluminum) so that microwaves do not leak from the system. But the canister vent line 18 extends through the microwave leak free container 26 to the canister 14. The EVAP canister 14 illustrated in FIG. 1 is a simplification of a typical canister.

As further illustrated in FIG. 1 an electrically activated and powered vacuum pump 28 may be used to assist the return of heated fuel vapor from the internally heated activated carbon bed to the cooler fuel tank. In another embodiment, any suitable pump or transfer device may be used to assist the movement of the fuel vapor from the canister to the fuel tank.

In FIG. 2 the microwave generator 22 is separate from the EVAP canister 14 and a waveguide 30 is used to carry the microwave radiation 24 into the bed of activated carbon 16. In the EVAP canister of FIG. 2 the activated carbon 16 may be contained within a material such as aluminum which prevents leakage of the microwave radiation.

In another embodiment (not shown), the microwave generator 22 is not on-board the vehicle. When the canister 14 needs to be regenerated, the canister may be temporarily attached to a microwave generator 22 module for regeneration.

In one embodiment, the canister 14 may be regenerated using the microwave generator 22 that is either on-board or off-board when the vehicle is plugged into a 110 volt AC system for battery charging. For example, when the operator plugs the vehicle into the 110 volt AC system, the control system of vehicle can determine if the canister needs to be regenerated. Using the power supply from the 110 volt AC outlet to regenerate the canister 14 eliminates the use of battery power for microwave regeneration. In one embodiment, the activated carbon particles 16 can be heated with microwave radiation to about 330° C. in about one to two minutes using the 110 volt AC power.

The control system of the vehicle may determine how often and how long the canister 14 needs to be regenerated. For example, the determination of when and how long to regenerate the canister 14 may be based on at least one of the internal combustion engine operation in the previous trip, the number of diurnal loadings, the ambient temperature, and the fuel level in the fuel tank. In one embodiment, the amount of vapor trapped in the canister can be estimated based on the change in ambient temperature and the amount of fuel in the fuel tank. The canister 14 may not need to be regenerated after every engine start. For example, if ambient temperatures are low and fuel level in the fuel tank is high, diurnal vapor generation will be very low and the canister may only need to be regenerated after a number of days. As another example, if the engine is in operation during a long-distance trip, there may be no need for microwave regeneration because the canister will have been purged using ambient air flow during engine operation. Regenerating the canister 14 only when necessary, rather than on a fixed schedule, may save a significant amount of energy.

Microwave energy can be used to selectively and internally heat activated carbon to elevated temperatures (>250° C.) so that the hydrocarbons desorb from the carbon and flow back into the fuel tank. The flow of desorbed hydrocarbons can be facilitated by using the vacuum pump 28 as stated above. Microwave regeneration of adsorbents had been studied extensively and found to be very effective in regenerating adsorbents such as activated carbon. Microwave heating provides uniform in-situ rapid heating and the container vessel can remain at room temperature while the material in it is heated. Another advantage of microwave generation is that heating is dependent on the dielectric properties of the adsorbate and/or adsorbent material rather than the purge gas flow rate during regeneration. Microwave heating is also volumetric, whereby all of the infinitesimal volume elements within the object are heated. Finally, in contrast to surface heating such as hot gas heating, the direction of the heat flux from microwave is from the inside to the outside of the workload. These properties can result in selective heating of fuel adsorbate material and with a large dielectric loss factor within the pores of a microwave transparent adsorbent. Such heating mechanism will allow for higher energy efficiency and more selective and rapid heating of the adsorbate and regeneration of the adsorbent.

A microwave heating system includes a high voltage transformer, which passes energy to a magnetron. The magnetron generates microwaves, which may be guided into a heating chamber using a waveguide. A microwave heater works by passing non-ionizing radiation, usually in the frequency range of 900 MHz to 2450 MHz (a commonly used frequency is 2450 MHz, a wavelength of 12.24 cm), through the material being heated. Microwave radiation is between common radio and infrared frequencies. Water and some other materials absorb energy from the microwaves in a process called dielectric heating. Many molecules (such as those of water) are electric dipoles, meaning that they have a positive charge at one end and a negative charge at the other, and therefore rotate as they try to align themselves with the alternating electric field induced by the microwaves. This molecular movement creates heat as the rotating molecules hit other molecules and put them into motion. Activated carbon particles adsorb microwaves which results in rapid heating of EVAP canister carbon. The frequency of the microwaves may be tailored to the dimensions of the activated carbon bed.

FIG. 3 is a schematic drawing of an evaporative control system 40 for a plug-in hybrid vehicle including an engine 42. The control system 40 includes the microwave generator 22 separate from the EVAP canister 14, as shown in FIG. 2. In another embodiment (not shown) the control system 40 may include the canister 14 contained within the microwave generator 22, as shown in FIG. 1.

Referring again to FIG. 3, the representative EVAP canister 14 is typically molded of a suitable thermoplastic polymer such as nylon. In one embodiment, the canister 14 comprises four side walls 44, a bottom closure 46 that is attached to the side walls 44, and a top 48 that define an internal volume and a rectangular cross section. The canister 14 has a vertical internal partition 50 that extends from the top 48 and the front and rear sides 44. The partition 50 within the canister 14 extends toward but short of the bottom closure 46. At the top of a canister is a vapor inlet opening 54 that also serves as an outlet for the flow of microwave purged vapors desorbed from the adsorbent material 16. Also formed in the top of the canister 14 on the other side of the vertical partition 50 is a canister vent opening 56 and the vent line 18 through which a stream of purge air enters the canister 14, and the vent line 18 is closed during microwave purging of the canister. Thus the partition 50 in the canister 14 extends the flow path of vapor from vapor inlet 54 to canister vent opening 56 because of the closed bottom. In another embodiment, the carbon canister 14 can be of cylindrical shape with one or more partitions with openings for air and vapor flow. A purpose of the partitions is to prevent vapor redistribution during long soak periods. Vapor redistributions tend to increase breakthrough emissions.

Connected to the vent line 18 is the canister vent solenoid-actuated sealing valve 20. The sealing valve 20 is closed only during microwave purging of the canister 14 and for EVAP system leak checks. In its closed position a stopper portion 58 of the sealing valve 20 is biased closed to cover a vent opening 60 in the air inlet line. Upon actuation of a battery-powered solenoid 62, the stopper 58 is moved to uncover the vent opening 60. The solenoid 62 is actuated upon command of the vehicle control module 76 through a signal lead 78. As stated, the sealing valve 20 is usually only opened during vehicle refueling and during suitable modes of engine operation.

A canister purge outlet 64 is connected by a purge line (second air and fuel vapor flow passage) 66 through a solenoid-actuated purge valve 68 to the engine 42. The purge valve 68 may include a battery-powered solenoid 70 and a stopper 72 to close a purge opening 74. The purge valve 68 is operated by the controller 76 through a signal lead 77 when the engine 42 is running and can accommodate a secondary air/fuel mixture. The purge valve 68 is closed at engine-off and is opened only by command of the control module when the engine 42 is running and can accommodate the secondary stream of fuel-laden air stream drawn through the canister 14.

When the engine 42 is in operation, the canister vent line 18 and the purge line 66 are open. When the vehicle is being refueled, the canister vent line 18 is open, but the purge line 66 is closed. When the canister is regenerated using microwave radiation, both the canister vent line 18 and the purge line 66 are closed.

When the engine 42 is started, the controller 76 receives signals from one or more engine sensors, transmission control devices, and/or emissions control devices. Line 78 from the engine 42 to the controller 76 schematically depicts the flow of sensor signals. During engine operation, gasoline is delivered from the fuel tank 10 by a fuel pump (not shown) through a fuel line (not shown) to a fuel rail. Fuel injectors inject gasoline into cylinders of the engine 42 or to ports that supply groups of cylinders. The timing and operation of the fuel injectors and the amount of fuel injected are managed by the controller 76.

The fuel tank 10 is typically a closed container except for the fuel vapor vent passage 12. The fuel tank 10 is often made of blow molded, high density polyethylene provided with one or more gasoline impermeable interior layer(s). The fuel tank 10 is connected to a fill tube 80. A gas cap 82 closes a gas fill end 84 of the fill tube 80. The outlet end 86 of the fill tube 80 is located inside of the fuel tank 10. A one-way valve 88 prevents gasoline from splashing out of the fill tube 88. An upper surface of the gasoline is identified at 90. A float-type fuel level indicator 92 provides a fuel level signal at 94 to the controller 76. A pressure sensor 96 and a temperature sensor 98 optionally provide pressure and temperature signals 100 and 102 to the controller 76. The vapor vent passage 12 extends from a seal 104 on the fuel tank 10 to the canister 14. A float valve 106 within the fuel tank 10 prevents liquid gasoline from entering the vapor vent passage 12.

As indicated above, the vehicle engine 42 may not run enough to suitably purge stored fuel from the EVAP canister 14. The microwave heating system and practice of this invention provides a method of purging fuel from the canister 14 in these circumstances. The outlet valves of the canister are closed and the flow of purged fuel vapor is directed back through the fuel tank vent line and into the relatively cool fuel tank.

In another embodiment of the invention two separate canisters may be provided for a plug-in hybrid fuel evaporation control system. One canister may be used for onboard refueling vapor recovery (ORVR) and the second canister may be used for diurnal emission control. The ORVR canister may be purged whenever the engine consumes fuel which requires no microwave regeneration. The diurnal canister will be purged using microwave regeneration whenever engine operation does not sufficiently purge the canister.

Practices of the invention have been shown by examples that are presented as illustrations and not limitations of the invention.

1. A method of operating a fuel evaporative emission control system in a plug-in hybrid vehicle driven by a battery powered electric motor with a supplemental gasoline engine powered-electric generator operated on-demand for supplemental electric power for the vehicle, where the vehicle comprises a gasoline fuel tank, a fuel vapor vent passage from the fuel tank to a fuel vapor adsorption canister with a fuel vapor adsorbing material, a first air and fuel vapor flow passage from the canister for venting the canister and for introduction of purge air to the canister to purge fuel vapor from the canister, and a second air and fuel vapor flow passage from the canister for passage of purge air and purged fuel vapor from the canister to an air induction system of the engine, the method comprising:
tracking the flow of fuel vapor from the fuel tank to the fuel vapor adsorption canister; and when the fuel content of the canister exceeds a predetermined level
selectively heating the fuel vapor adsorbing material of the adsorption canister with microwave radiation to purge fuel vapor from the canister back through the fuel vapor vent passage into the fuel tank.

2. A method of operating a fuel evaporative emission control system as recited in claim 1 further comprising pumping fuel vapor from the canister to the fuel tank using a vacuum pump in the fuel vapor vent passage to assist flow of the fuel vapor back into the fuel tank.

3. A method of operating a fuel evaporative emission control system as recited in claim 1 in which the source of the microwave radiation is a microwave generator and the canister is enclosed in the microwave generator.

4. A method of operating a fuel evaporative emission control system as recited in claim 1 in which the source of the microwave radiation is a microwave generator that is connected to the canister by a wave guide.

5. A method of operating a fuel evaporative emission control system as recited in claim 1 in which the source of the microwave radiation is a microwave generator that is off-board the plug-in hybrid vehicle.

6. A method of operating a fuel evaporative emission control system as recited in claim 1 further comprising:
opening the first and second air and fuel vapor passages during engine operation;
opening the first air and fuel vapor passage, but not the second air and fuel flow passage, when the vehicle is not operating and the gasoline is being added to the fuel tank;
tracking the flow of fuel vapor from the fuel tank to the fuel vapor adsorption canister; and when the fuel content of the canister exceeds a level and both the first and second air and fuel vapor passages are closed,
selectively heating the fuel vapor adsorbing material of the adsorption canister with microwave radiation to purge fuel vapor from the canister back through the fuel vapor vent passage into the fuel tank.

7. A method of operating a fuel evaporative emission control system as recited in claim 6 further comprising pumping fuel vapor from the canister to the fuel tank using a vacuum pump in the fuel vapor vent passage to assist flow of the fuel vapor back into the fuel tank.

8. A method of operating a fuel evaporative emission control system as recited in claim 6 in which the source of the microwave radiation is a microwave generator and the canister is enclosed in the microwave generator.

9. A method of operating a fuel evaporative emission control system as recited in claim 6 in which the source of the microwave radiation is a microwave generator that is connected to the canister by a wave guide.

10. A method of operating a fuel evaporative emission control system as recited in claim 6 in which the source of the microwave radiation is a microwave generator that is off-board the plug-in hybrid vehicle.

11. A method of operating a fuel evaporative emission control system as recited in claim 1 in which the fuel vapor adsorbing material comprises activated carbon particles.

12. An apparatus for a plug-in hybrid vehicle driven by a battery powered electric motor with a supplemental gasoline engine powered-electric generator operated on-demand for supplemental electric power for the vehicle, the apparatus comprising:
a gasoline fuel tank;
a fuel vapor vent passage from the fuel tank to a fuel vapor adsorption canister having a fuel vapor adsorbing material;
a first air and fuel vapor flow passage from the canister for venting the canister and for introduction of purge air to the canister to purge fuel vapor from the canister;
a second air and fuel vapor flow passage from the canister for passage of purge air and purged fuel vapor from the canister to an air induction system of the engine; and
a microwave generator in communication with the canister.

13. An apparatus as recited in claim 12 in which the canister is enclosed in the microwave generator.

14. An apparatus as recited in claim 12 in which the microwave generator is connected to the canister by a waveguide.

15. An apparatus as recited in claim 12 further comprising a vacuum pump in the fuel vapor vent passage.

16. An apparatus as recited in claim 12 in which the fuel vapor adsorbing material comprises activated carbon particles.
